(19) United States
(12) Patent Application Publication
(10) Pub. No.: US 2012/0048063 A1
(43) Pub. Date: Mar. 1, 2012

(54) HIGH COMPRESSIBILITY IRON POWDER, AND IRON POWDER FOR DUST CORE AND DUST CORE USING THE SAME

(75) Inventors: Toshio Maetani, Chiba (JP); Satoshi Uenosono, Osaka (JP); Aya Uenosono, Osaka (JP); Masateru Ueta, Kanagawa (JP)

(73) Assignee: JFE STEEL CORPORATION a corporation of Japan, Tokyo (JP)

(21) Appl. No.: 12/443,993

(22) PCT Filed: Jan. 30, 2007
(86) PCT No.: PCT/JP2007/051879

§ 371 Date: Jul. 29, 2011

(51) Int. Cl. B32B 15/02; C22C 38/02; C22C 38/04; B32B 5/16; B22F 9/08; B05D 7/00; B22F 3/02; C22C 38/00; B22F 1/00

(52) U.S. Cl. 75/246; 420/128; 75/337; 427/216; 419/66; 428/403

(57) ABSTRACT

High compressibility iron powder that is suitably used for parts with excellent magnetic characteristics or high density sintered parts and that has good productivity is provided from pure iron powder which includes, as impurities in percent by mass, C: 0.005% or less, Si: more than 0.01% and 0.03% or less, Mn: 0.03% or more and 0.07% or less, P: 0.01% or less, S: 0.01% or less, O: 0.10% or less, and N: 0.001% or less, and whose particle includes four or less crystal grains on average and has a micro Vickers hardness (Hv) of 80 or less on average. The circularity of the iron powder is preferably 0.7 or more.

### RELATED APPLICATIONS

This is a §371 of International Application No. PCT/JP2007/051879, with an international filing date of Jan. 30, 2007 (WO 2008/093430 A1, published Aug. 7, 2008).

### TECHNICAL FIELD

This disclosure relates to iron powder for powder metallurgy and, in particular, to high compressibility iron powder suitable for parts that require excellent magnetic characteristics or parts that require high density. The disclosure also relates to iron powder for a dust core and a dust core using the high compressibility iron powder.

### BACKGROUND

Near-net-shape manufacture of parts that require high dimensional accuracy and have a complex shape has been realized with the progress of powder metallurgical technologies. Thus, products adopting such powder metallurgical technologies are utilized in various areas.

In the powder metallurgical technologies, a green compact is obtained from metal powder, which may be mixed with lubricant powder or alloying powder as necessary, in a pressure forming process with a die. Subsequently, the green compact is sintered and further heat-treated to obtain sintered parts having a desired shape and size and desired characteristics. In the powder metallurgical technologies, a green compact is also obtained from metal powder, which is mixed with a binder such as a resin, in a pressure forming process with a die, and the obtained green compact itself may be used as a dust core.

In manufacturing parts having excellent magnetic characteristics or high strength by utilizing such powder metallurgical technologies, a green compact with higher density needs to be obtained after a pressure forming process at a determinate pressure. In other words, metal powder (iron powder) for such applications needs to have high compressibility.

To meet such a demand, pure iron powder for powder metallurgy having the following specifications is proposed in Japanese Examined Patent Application Publication No. 8-921 (or Japanese Unexamined Patent Application publication No. 6-2007):
The impurity content is C: 0.005% or less, Si: 0.010% or less, Mn: 0.050% or less, P: 0.010% or less, S: 0.010% or less, O: 0.10% or less, and N: 0.0020% or less with the balance being substantially Fe and incidental impurities;
The particle size distribution is, on the basis of weight percent by sieve classification using sieves defined in JIS Z 8801, constituted by 4% or less of particles of −60/+83 mesh, 4% to 10% of particles of −83/+100 mesh, 10% to 25% of particles of −100/+140 mesh, and 10% to 30% of particles passing through a sieve of 330 mesh; and
Crystal grains with an average diameter included in particles of −60/+200 mesh are coarse crystal grains with a grain size number of 6.0 or less measured by a ferrite grain size measuring method defined in JIS G 0052.

Note that −60/+83 mesh means particles pass through a sieve of 60 mesh (nominal dimension (nominal opening) of 250 μm) and do not pass through a sieve of 83 mesh (nominal dimension of 165 μm). When the pure iron powder disclosed in Japanese Examined Patent Application Publication No. 8-921 to which 0.75% of zinc stearate relative to the mixed powder is blended as a lubricant is compacted with a die at a compacting pressure of 5 t/cm² (490 MPa), a green density of 7.05 g/cm³ (7.05 Mg/m³) or more is allegedly achieved.

High compressibility iron powder having the following properties is proposed in Japanese. Unexamined Patent Application Publication No. 2002-317204:
The particle size distribution of iron powder is, on the basis of mass percent by sieve classification using sieves defined in JIS Z 8801, constituted by more than 0% and 45% or less of particles that pass through a sieve having a nominal dimension of 1 mm and do not pass through a sieve having a nominal dimension of 250 μm, 30% to 65% of particles that pass through a sieve having a nominal dimension of 250 μm and do not pass through a sieve having a nominal dimension of 180 μm, 4% to 20% of particles that pass through a sieve having a nominal dimension of 180 μm and do not pass through a sieve having a nominal dimension of 150 μm, and 0% to 10% of particles that pass through a sieve having a nominal dimension of 150 μm; and
The micro Vickers hardness of iron powder particles that do not pass through the sieve having a nominal dimension of 150 μm is 110 or less.

The impurity content of this high compressibility iron powder is preferably C: 0.005% or less, Si: 0.01% or less, Mn: 0.05% or less, P: 0.01% or less, S: 0.01% or less, O: 0.10% or less, and N: 0.003% or less by mass. When the iron powder disclosed in Japanese Unexamined Patent Application Publication No. 2002-317204 to which 0.75% of zinc stearate is blended as a lubricant is compacted with a die at a compacting pressure of 490 MPa, a green density of 7.20 Mg/m³ or more is achieved.

Soft magnetic pure iron powder or soft magnetic alloy powder in which the number of crystal grains per particle is 10 or less on average in a cross-section is proposed in Japanese Unexamined Patent Application Publication No. 2002-121601. To obtain the soft magnetic pure iron powder or the soft magnetic alloy powder described in Japanese Unexamined Patent Application Publication No. 2002-121601, heating to a high temperature, preferably 800° C. or more, in a non-oxidation atmosphere is necessary. Manufacturing a dust core using such pure iron powder or alloy powder allegedly improves the permeability of the dust core.

A method for manufacturing a soft magnetic green compact that utilizes metal powder particles composed of monocrystals of a soft magnetic metal is disclosed in Japanese Unexamined Patent Application Publication No. 2002-275505. In the technologies described in Japanese Unexamined Patent Application Publication No. 2002-275505, soft magnetic raw powder particles composed of polycrystals are heated to a high temperature, preferably 1100 to 1350° C., in a reduction atmosphere to form monocrystals. Manufacturing a green compact using such a metal powder improves the maximum permeability of the green compact.

However, the obtained green density of the pure iron powder described in Japanese Examined Patent Application Publication No. 8-921 is only about 7.12 g/cm³ (7.12 Mg/m³) at most, whose compressibility is not high enough. Therefore, in the case where such pure iron powder is used as magnetic parts such as cores, desired magnetic characteristics such as magnetic flux density and permeability are sometimes not obtained.

Since the iron powder described in Japanese Unexamined Patent Application Publication No. 2002-317204 has large particle sizes, there is a concern about strength reduction after sintering. The high purity necessary for such an iron powder also increases refining cost. Furthermore, manufacturing economies of scale cannot be achieved because the particle size distribution is significantly different from that of iron powder used for, for example, general powder metallurgy, resulting in an increase in cost.

In the technologies described in Japanese Examined Patent Application Publication No. 8-921 and Japanese Unexamined Patent Application Publication No. 2002-317204, the content of Si is decreased to 0.010% or less by mass. As for normal iron powder, however, this composition makes it difficult to control components in the refining process.

In the technology described in Japanese Unexamined Patent Application Publication No. 2002-121601, a smaller number of crystal grains per metal powder particle are preferred. However, heating to a high temperature, 1000° C. or more, in a non-oxidation atmosphere is required to decrease the number of crystal grains to five or less. In the technology described in Japanese Unexamined Patent Application Publication No. 2002-275505, metal powder particles need to be heated to a high temperature, 1100° C. or more, in a reduction atmosphere to form monocrystals. In other words, both the technologies described in Japanese Unexamined Patent Application Publications No. 2002-121601 and No. 2002-275505 require a furnace operated in a non-oxidation atmosphere at high temperature, resulting in an increase in manufacturing cost. Moreover, such a high temperature process does not improve the compressibility as expected.

It could therefore be helpful to provide high compressibility iron powder that is suitably used for parts with excellent magnetic characteristics or high density sintered parts and that also has good productivity (including low cost). It could also be helpful to provide iron powder for a dust core and a dust core using the high compressibility iron powder.

### SUMMARY

It has been considered that iron powder needs to be highly purified to obtain high compressibility iron powder. For example, the content of Si virtually needs to be 0.010% or less. However, we examined various factors that affect the hardness of iron powder particles, using iron powder with a certain purity close to that of iron powder that has been commonly manufactured, without purifying the iron powder to an unnecessarily high level.

As a result, we discovered that pure iron powder with good compressibility was obtained by changing the manufacturing process (e.g., reduction conditions or reannealing after a reduction process) of iron powder to moderately reduce the content of N or the like, change the number of crystal grains in an iron powder particle to four or less, and to achieve a micro Vickers hardness (Hv) of 80 or less on average, even if a melt with a certain purity close to that of a molten metal that has been commonly manufactured was used.

We also discovered that the compressibility of iron powder was improved by making the circularity of the iron powder 0.7 or more.

We thus provide:
(1) High compressibility iron powder characterized in that iron powder includes, in percent by mass, C: 0.005% or less, Si: more than 0.01% and 0.03% or less, Mn: 0.03% or more and 0.07% or less, P: 0.01% or less, S: 0.01% or less, O: 0.10% or less, and N: 0.001% or less; the number of crystal grains included in a particle of the iron powder is four or less on average in a cross-section of the particle; and the particle has a micro Vickers hardness (Hv) of 80 or less on average, preferably 75 or less.
(2) The high compressibility iron powder according to (1) characterized in that the circularity of the particle is 0.7 or more on average.
(3) The high compressibility iron powder according to (1) or (2) characterized in that the particle includes inclusions such that the ratio of the number of the inclusions containing Si and having a size of 50 nm or more to the total number of the inclusions containing Si is 70% or more.
(4) The high compressibility iron powder according to any one of (1) to (3) characterized in that the iron powder is atomized iron powder manufactured by a water atomizing method.
(5) Iron powder for a dust core is obtained by conducting an insulation coating process on the high compressibility iron powder according to any one of (1) to (4).
(6) A dust core is obtained by compacting the iron powder for a dust core according to (5).

### BRIEF DESCRIPTION OF DRAWINGS

FIG. 1 is a schematic view showing a cross-sectional microstructure of an iron powder particle.

### REFERENCE NUMERALS

1 crystal grain surrounded by only grain boundaries
2 crystal grains surrounded by grain boundaries and a surface of an iron powder particle

### DETAILED DESCRIPTION

### Structure of Iron Powder

Our high compressibility iron powder has four or less crystal grains per iron powder particle on average and a micro Vickers hardness (Hv) of 80 or less on average, preferably 75 or less.

The term “high compressibility” is described as follows. After 0.75% by mass of zinc stearate is blended as a lubricant into 1000 g of iron powder, the blend is mixed using a V type mixer for 15 minutes. Subsequently, the mixture is compacted into a cylindrical shape, 11 mmφ×10 mm high, at room temperature at a compacting pressure of 686 MPa in a single compacting process. When the obtained green compact has a green density of 7.24 Mg/m³ or more after the compacting process, the iron powder has “high compressibility.”

When iron powder is used for general powder metallurgy such as making machine parts, about 0.5 to 0.9% by mass of graphite powder is normally mixed in addition to alloying elements, which decreases the green density. Therefore, the compressibility should be evaluated with the results obtained by compacting iron powder without mixing graphite powder.

The particle size distribution of the iron powder is not particularly limited. However, it is better for the particle size distribution to be within that of generally used iron powder to achieve a low manufacturing cost due to manufacturing economies of scale.

For example, on the basis of mass percent by sieve classification using sieves defined in JIS Z 8801, the particle distribution is preferably constituted by 30% or less particles that do not pass through a sieve having a nominal dimension (nominal opening) of 150 μm, more preferably 15% or less particles.

More preferably, the particle size distribution is, on the basis of mass percent by sieve classification, constituted by
more than 0% and 5% or less particles that do not pass through a sieve having a nominal dimension of 180 μm (+180 μm),
3% or more and 10% or less particles that pass through a sieve having a nominal dimension of 180 μm and do not pass through a sieve having a nominal dimension of 150 μm (−180 μm/+150 μm),
10% or more and 25% or less particles that pass through a sieve having a nominal dimension of 150 μm and do not pass through a sieve having a nominal dimension of 106 μm (−150 μm/+106 μm),
20% or more and 30% or less particles that pass through a sieve having a nominal dimension of 106 μm and do not pass through a sieve having a nominal dimension of 75 μm (−106 μm/+75 μm),
10% or more and 20% or less particles that pass through a sieve having a nominal dimension of 75 μm and do not pass through a sieve having a nominal dimension of 63 μm (−75 μm/+63 μm),
15% or more and 30% or less particles that pass through a sieve having a nominal dimension of 63 μm and do not pass through a sieve having a nominal dimension of 45 μm (−63 μm/+45 μm), and
15% or more and 30% or less particles that pass through a sieve having a nominal dimension of 45 μm (−45 μm).
   This particle size distribution is the same as that of commercial atomized iron powder for powder metallurgy described in Table 1 (below).

The number of crystal grains in an iron powder particle is specified as four or less on average. When the number of crystal grains in an iron powder particle is four or less, the compressibility of the iron powder is improved. On the other hand, when the number of crystal grains in an iron powder particle is more than four, the compressibility of the iron powder is decreased. The reason for this is described below.

An increase in the number of crystal grains in an iron powder particle means an increase in the number of grain boundaries. The grain boundaries are composed of a pile-up of dislocations, that is, a kind of lattice defect. An increase in the number of grain boundaries hardens the iron powder particles, which leads to a reduction in the compressibility of the iron powder. Accordingly, the number of crystal grains in an iron powder particle is specified as four or less on average.

The “number of crystal grains in an iron powder particle” is the number of crystal grains in a cross-section of the iron powder particle and the value is determined by the following measurement.

First, iron powder to be measured is mixed with thermoplastic resin powder to make mixed powder. After the mixed powder is placed in an appropriate die, the resin is melted by applying heat and then cured by cooling to form cured resin containing iron powder. Next, an arbitrary cross-section of the cured resin containing iron powder is cut off, polished, and etched. After that, the microstructure of the iron powder is observed and/or photographed with an optical microscope or a scanning electron microscope (×400), and the number of crystal grains in an iron powder particle is measured. The determination of the number of crystal grains is preferably performed using an image analysis apparatus on the basis of the microstructure image.

The average number of crystal gains is determined as follows. Thirty iron powder particles to be observed and/or photographed by the above-mentioned method are selected. The numbers of crystal grains in iron powder particles are averaged, and the average value is referred to as the average number of crystal grains in an iron powder particle. The particles for determining the number of crystal grains are selected from the particles whose long axis (the longest line segment in the particle cross-section) is 50 μm or more.

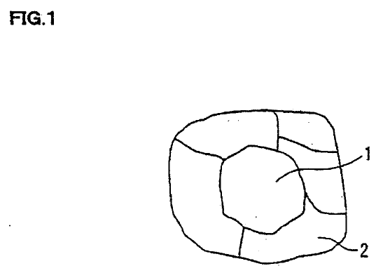

To describe the number of crystal grains, crystal grains in an iron powder particle are schematically shown in FIG. 1. As shown in FIG. 1, the iron powder particle includes two types of crystal grains such as a crystal grain 1 surrounded by only grain boundaries and crystal grains 2 surrounded by grain boundaries and a surface of an iron powder particle. The number of crystal grains in an iron powder particle is the sum of the numbers of the crystal grain 1 and the crystal grains 2, and the number is six in FIG. 1.

The iron powder particles have a micro Vickers hardness (Hv) of 80 or less on average. If the iron powder particles have a micro Vickers hardness (Hv) of more than 80, the compressibility of iron powder decreases and high compressibility (to obtain a green compact whose green density is 7.24 Mg/m³ or more by blending iron powder and 0.75% by mass of zinc stearate as a lubricant and then by compacting the blend at room temperature at a compacting pressure of 686 MPa in a single compacting process) cannot be achieved. Therefore, the strength decreases in the case where a sintered compact is formed, and the magnetic characteristics are degraded in the case where a dust core is formed. Preferably, the iron powder particles have a micro Vickers hardness (Hv) of 75 or less.

To obtain the target value of the micro Vickers hardness (Hv), the chemical composition and manufacturing conditions may be controlled in accordance with the requirement described below.

In a similar manner as the measurement of “the number of crystal grains in an iron powder particle,” the hardness of the iron powder particles is determined. After the cured resin containing iron powder is formed, an arbitrary cross-section of the cured resin containing iron powder is cut off and polished. Cross-sections of the particles are then measured with a micro Vickers hardness tester (load 25 gf (0.245 N)). One point around the center in each of the cross-sections of ten or more particles is measured, and the average measurement value of the particles is used as the hardness of the iron powder particles.

Next, the circularity of the iron powder is preferably 0.7 or more. By bringing the shape of iron powder particles closer to a globular shape, for example, making the circularity of the iron powder 0.7 or more, the particles have less contact points and the contact resistance among the particles decreases. Therefore, iron powder particles filled in a die become easily movable in a pressure forming process, and the rearrangement of particles (the relative positions of particles change so as to decrease the space thereamong) that occurs before plastic deformation is promoted. As a result, since the iron powder is densified at an early stage of a pressure forming process, the compressibility of the iron powder is improved.

Although an iron powder having such a shape is manufactured by a gas atomizing method, the iron powder can also be manufactured by a low-pressure water atomizing method. That is, the circularity of the iron powder can be controlled by adjusting the water pressure and cooling rate of the atomization.

Alternatively, an iron powder having such a shape can be manufactured by a method in which iron powder having no regular form obtained by a crushing method, an oxide reduction method, or a normal high-pressure water atomizing method is mechanically struck such that the surfaces of the powder particles are smoothed. However, since the iron powder manufactured by these methods is work hardened, it requires stress relief annealing.

In consideration of productivity (including manufacturing cost), the low-pressure water atomizing method is most desirable.

The circularity of iron powder is preferably 0.9 or more. However, the gas atomizing method is normally required to achieve such circularity, which is disadvantageous in terms of productivity.

Even a circularity of about 0.7 to 0.8 provides sufficient compressibility and an iron powder with such circularity can be manufactured by the water atomizing method. Therefore, an iron powder with a circularity of about 0.7 to 0.8 is preferable in consideration of productivity.

The circularity of iron powder is the value defined by the following equation (1):

Circularity=(Circumference of Equivalent Circle)/(Circumference of Particle) equation (1).

The circularity of iron powder is determined as follows.

First, iron powder to be measured is mixed with thermoplastic resin powder to make mixed powder. After the mixed powder is placed in an appropriate die, the resin is melted by applying heat and then cured by cooling to form cured resin containing iron powder. Next, an arbitrary cross-section of the cured resin containing iron powder is cut off and polished. After that, the microstructure of the iron powder is observed and/or photographed with an optical microscope or a scanning electron microscope (×400). From the obtained cross-sectional image, the circumference and the projected area of each particle are measured. From the measured projected area of each particle, the diameter of a circle (equivalent circle) that has an area equivalent to the projected area is calculated. Subsequently, the circumference of the equivalent circle of the particle is calculated from the obtained diameter. The circularity is calculated from the obtained circumference of the equivalent circle and the obtained circumference of each particle using the above-mentioned equation (1). Ten or more particles to be measured are selected and the average value of the circularity of the particles is used as the circularity of the iron powder. The particles for determining the circularity are selected from the particles whose long axis is 50 μm or more.

### Chemical Composition and Form of the Elements of Iron Powder

The high compressibility iron powder includes, as impurities in percent by mass, C: 0.005% or less, Si: more than 0.01% and 0.03% or less, Mn: 0.63% or more and 0.07% or less, P: 0.01% or less, S: 0.01% or less, O: 0.10% or less, and N: 0.001% or less, with the balance being Fe and incidental impurities. Each component will be described hereinafter.

C: 0.005% or less by mass

When the content of C is more than 0.005% by mass, which is a large amount, the hardness of the iron powder is increased and the compressibility of the iron powder is reduced. Thus, the content of C is limited to 0.005% or less by mass. The industrially reasonable minimum content of C is about 0.0005% by mass.

Si: more than 0.01% by mass (the same meaning as more than 0.010% by mass) and 0.03% or less by mass

To achieve high compressibility by decreasing the hardness of iron powder particles, the content of Si is normally decreased to 0.010% or less by mass. However, when the content of Si is 0.01% or less by mass, the melting loss of refractories, nozzle clogging during atomization, or the like is likely to occur and the refining cost may also increase. On the other hand, when the content of Si is more than 0.03% by mass, the hardness of the iron powder is increased and compressibility is reduced.

Instead of conventional ways, therefore, the content of Si is limited to more than 0.01% and 0.03% or less by mass and a new requirement that achieves high compressibility even in such a Si content range is found and adopted.

Mn: 0.03% or more by mass and 0.07% or less by mass

When the content of Mn is less than 0.03% by mass, the melting loss of refractories, nozzle clogging during atomization, or the like is likely to occur and the refining cost may also increase. On the other hand, when the content of Mn is more than 0.07% by mass, the hardness of the iron powder is increased and compressibility is reduced. Therefore, the content of Mn is limited to 0.03% or more by mass and 0.07% or less by mass.

P: 0.01% or less by mass

When the content of P is more than 0.01% by mass, which is a large amount, the hardness of the iron powder is increased and compressibility is reduced. Thus, the content of P is limited to 0.01% or less by mass. The industrially reasonable minimum content of P is about 0.005% by mass.

S: 0.01% or less by mass

When the content of S is more than 0.01% by mass, which is a large amount, the hardness of the iron powder is increased and compressibility is reduced. Thus, the content of S is limited to 0.01% or less by mass. The industrially reasonable minimum content of S is about 0.005% by mass.

O: 0.10% or less by mass

When the content of O is more than 0.10% by mass, the hardness of the iron powder increases and compressibility is reduced. Thus, the content of O is limited to 0.10% or less by mass. The industrially reasonable minimum content of O is about 0.03% by mass.

N: 0.001% or less by mass

The content of N is particularly limited to 0.001% or less by mass. When the content of N is more than 0.001% by mass, the hardness of the iron powder is increased and compressibility is reduced. Thus, the content of N is limited to 0.001% or less by mass. The content of N can be reduced easily by carrying out a reduction process under high heat load or denitrification through the reannealing after such a reduction process as described below. Thus, use of a general grade of denitrification process is acceptable at the refining stage (denitrification as much as possible is not prohibited). Although this slightly increases manufacturing cost, the decrease in productivity is less than the case in which the reduction in the content of Si to 0.01.0% or less by mass is performed at the refining stage. The composition of a melt obtained in a standard refining process can be utilized.

The content of N is preferably 0.0010% or less by mass. The industrially reasonable minimum content of N is about 0.0003% by mass.

The range of the impurity content described above is the same as that of general iron powder for powder metallurgy except for the low content of N. There is no particular problem even if secondary impurities other than the above are contained in a range in which they do not affect the characteristics of the iron powder.

In the high compressibility iron powder, other alloying elements are preferably not intentionally added to the main iron powder. However, alloying elements such as Ni, Cu, and Mo can be partially alloyed on the surface of the iron powder, or can also be adhered to the surface of the iron powder through a binding agent when necessary.

When the iron powder is manufactured particularly for a dust core, the ratio of the number of inclusions in the iron powder containing Si and having a size of 50 nm or more to the total number of inclusions containing Si is preferably adjusted to 70% or more.

The thickness of the domain walls of iron powder particles is assumed to be about 40 nm (refer to Soshin Chikazumi: Kyoujiseitai no Butsuri (Ge)—Jikitokusei to Ouyou—[Physics of Ferromagnetism, Vol. II—Magnetic Characteristics and Engineering Application—]; Shokabo Publishing: 1987; pp 174). If the size of each of the inclusions containing Si is less than 50 nm, the domain wall motion in the iron powder particles is assumed to be blocked when a magnetic field is applied. Therefore, the ratio of the number of inclusions in the iron powder containing Si and having a size of 50 nm or more, whose effect on magnetic characteristics are smaller, to the total number of inclusions containing Si is preferably adjusted to 70% or more, whereby a large amount of the inclusions having a size of 50 nm or more exists. This does not significantly increase the coercive force of the iron powder. For the dust core, deterioration of the magnetic characteristics such as coercive force, permeability, and core loss is reduced. If more than 30% of the inclusions containing Si and having a size of less than 50 nm exist in the iron powder particles, the influence thereof on the magnetic characteristics increases.

The size of each of the inclusions containing Si is more preferably 100 nm or more. That is, the ratio of the number of the inclusions containing Si and having a size of 100 nm or more to the total number of the inclusions containing Si is preferably 70% or more.

The size of each of the inclusions containing Si is measured by the following method. An arbitrary cross-section of cured resin containing iron powder is cut off, polished, and etched. Elements contained in the inclusions of the iron powder particles are identified by energy dispersive X-ray fluorescence spectroscopy (EDX). The largest dimension (long axis) of each of the inclusions containing Si is measured with a scanning electron microscope or the like to obtain the size of each of the inclusions. Twenty of the inclusions containing Si are selected to be measured.

### Method for Manufacturing Iron Powder

Next, a preferable method for manufacturing the iron powder will be described.

In manufacturing the iron powder, any well-known iron powder manufacturing method such as a reduction method or an atomizing method is normally applicable. Although not particularly limited, a water atomizing method in which a melt is water-atomized into iron powder is preferably applied in terms of compressibility and productivity. A preferable method for manufacturing the iron powder will be described by taking an example of manufacturing atomized iron powder using the water atomizing method. Obviously, our methods are not limited to this.

Water atomized iron powder is obtained by directing high-pressure water jets against a melt having a common pure iron composition, disintegrating the melt, and solidifying it through rapid cooling. Subsequently, a product (iron powder) in which the oxide film on the particle surfaces are removed is obtained after the water atomized iron powder is dehydrated, dried, and reduced. Although the content of N in the atomized iron powder may be reduced as much as desired, the content of N obtained using a normal method is acceptable.

To adjust the circularity of the iron powder particles to about 0.7 to 0.8, the pressure of the high-pressure water jets may be reduced to, for example, about 60 to 80% of that used in the conventional method.

The reduction process is preferably carried out in a reduction atmosphere containing hydrogen under high heat load. Preferably, for example, the heat treatment in a reduction atmosphere containing hydrogen at a temperature of 700° C. or more and less than 1000° C., more preferably 800° C. or more and less than 1000° C., for a holding time of 1 to 7 h, more preferably 3 to 5 h is carried out in a single step or a plurality of steps. More preferably, the keeping temperature is 800° C. to 950° C. and the holding time is 3.5 to 5 h.

The flow rate of a reducing gas (hydrogen) is preferably 0.5 NL/min/kg or more relative to the iron powder. A dew point in the atmosphere is not necessarily particularly specified but may be determined in accordance with the amount of C in green powder.

The upper limit temperature in the reduction process is specified because iron powder particles heated at a high temperature of more than 0.950° C., particularly 1000° C. or more, easily form strong bonds with each other. In other words, since a mechanically strong detaching process for the particles is required to disintegrate the powder particles that have formed bonds at high temperature, excess stress is applied to the particles, which adversely hardens the powder particles due to the stress left in the particles. Because of this adverse effect, a high temperature treatment does not provide sufficient compressibility.

After a reduction process, disintegration of iron powder and stress relief annealing of the iron powder can be carried out at a temperature of 700 to 850° C. In particular, annealing (reannealing) of iron powder in a dry hydrogen atmosphere is recommended for the purpose of more nitrogen reduction, more grain growth, and more of a decrease in hardness. When the composition, the number of crystal grains, and the hardness of iron powder are sufficiently achieved after a reduction process, reannealing may be conducted as an option.

Furthermore, a treatment such as disintegration, classification, or the like can be carried out as necessary. However, a mechanical treatment such as disintegration is preferably controlled not to exceed the required extent of the treatment, to prevent unnecessary hardening of particles.

By treating iron powder under the high heat load described above, the number of crystal grains in the iron powder particles can be decreased to four or less.

The reduction process under the high heat load described above is effective to adjust, to 70% or more, the ratio of the number of inclusions containing Si and having a size of 50 nm or more, preferably 100 nm or more, to the total number of inclusions containing Si. In other words, the reduction process under high heat load releases Si to the outside of iron powder particles by diffusing it through grain boundaries. This can reduce the content of Si in the iron powder particles, thereby reducing the number of inclusions containing Si, while at the same time the size of the inclusions can be increased.

### Application of Iron Powder

When the iron powder is applied to magnetic parts such as dust cores, insulating layers having a film structure that cover the surfaces of iron powder particles in layers are preferably formed by conducting an insulation coating process on iron powder.

The material for the insulation coating is not limited as long as the insulation properties required even after iron powder is formed into a desired shape in a pressure forming process are maintained.

Examples of the material include oxides of Al, Si, Mg, Ca, Mn, Zn, Ni, Fe, Ti, V, Bi, B, Mo, W, Na, and K. Such oxides include magnetic oxides such as spinel ferrite.

An amorphous material such as water glass can also be used.

Other examples of the material for the insulation coating include phosphate films and chromate films. The phosphate films may include boric acid and Mg.

Still other examples of the material for the insulation coating include phosphate compounds such as aluminum phosphate, zinc phosphate, calcium phosphate, and iron phosphate.

Furthermore, organic resins such as an epoxy resin, a phenol resin, a silicone resin, and a polyimide resin may be used. The film material containing a silicone resin and a pigment disclosed in Japanese Unexamined Patent Application Publication No. 2003-303711 may also be used as the material for the insulation coating without problem.

A surfactant or a silane coupling agent may be added to improve the adhesive force of the insulating material to the surfaces of the iron powder particles or to improve the uniformity of the insulating layers. The additive amount of the surfactant or the silane coupling agent is preferably in the range from 0.001 to 1% by mass relative to the total amount of the insulating layers.

The thickness of the insulating layers to be formed is preferably about 10 to 10000 nm. When the thickness is less than 10 nm, insufficient insulation effect is obtained. When the thickness is more than 10000 nm, high magnetic flux density is not obtained due to a decrease in the density of the magnetic parts.

Well-known film forming methods (coating methods) are suitably applied to the method for forming insulating layers on the surfaces of iron powder particles. Examples of the coating methods that can be used include a fluidized bed method, a dipping method, and a spraying method. In any method, since the insulating material is applied after being dissolved or dispersed in a solvent, a process for drying the solvent is required during or after the coating process. To promote the adhesion of the insulating layers to the iron powder particles and to prevent the insulating layers from being peeled off in a pressure forming process, a reaction layer may be formed between the insulating layers and the surfaces of the iron powder particles. The reaction layer is preferably formed by a chemical conversion treatment.

A dust core can be obtained, through a pressure forming process, from the iron powder (insulating-coated iron powder) in which insulating layers are formed on the surfaces of iron powder particles by the insulation coating process described above.

Any well-known pressure forming method can be applied. Examples of the method include a die forming method in which pressure forming is conducted at normal temperature using a uniaxial press, a warm compaction method in which pressure forming is conducted under a warm condition, a die lubrication method in which pressure forming is conducted by lubricating a die, a warm die lubrication method in which the die lubrication method is conducted under a warm condition, a high pressure forming method in which pressure forming is conducted at high pressure, and an isostatic pressing method.

Before the pressure forming, a lubricant such as a metallic soap or an amide wax can be blended with the iron powder as necessary. The blending amount of the lubricant is preferably 0.5 parts or less by mass relative to 100 parts by mass of the iron powder, because this further increases the density of the dust core.

The dust core can be annealed for the purpose of stress relief as necessary. In this case, the annealing temperature is preferably determined in the range from 200 to 800° C. in accordance with the heat resistance properties of the insulating layers.

The preferable density of the dust core is 7.2 to 7.7 Mg/m³ depending on its application. When high magnetic flux density and high permeability are required, the density is 7.5 to 7.7 Mg/m³.

### EXAMPLES

### Example 1

Atomized green powder was obtained from a melt (iron) made in an electric furnace through a water atomizing process. The melt was refined in a normal manner without undergoing a special treatment. The water atomizing process was carried out with the adjustment of atomizing pressure or the like. The obtained water atomized iron powder was dehydrated, dried, reduced, and then, disintegrated to prepare water atomized pure iron powder. The reduction conditions were changed in the temperature range of 800 to 990° C. and in the holding time range of 3 to 5 h in a reduction atmosphere (hydrogen concentration: 100%, dew point: 10 to 40° C.). In addition, stress relief annealing also having an effect on denitrification was carried out by holding the iron powder at a temperature of 830° C. in a dry hydrogen atmosphere for 2 h.

First, the particle size distribution of the obtained pure iron powders (A to Z and AA to AC) was measured on the basis of sieve classification using sieves defined in JIS Z 8801. The particle size distribution of any of the pure iron powders was within the normal range as shown in Table 1.

TABLE 1

| | | Particle Size Distribution (mass %) | | | | | | |
|---|---|---|---|---|---|---|---|---|
| | | Nominal Dimension of Sieve (μm)* | | | | | | |
| Iron Powder No. | | +180 | −180/+150 | −150/+106 | −106/+75 | −75/+63 | −63/+45 | −45 |
| Commercial | Range | 0-5 | 3-10 | 10-25 | 20-30 | 10-20 | 15-30 | 15-30 |
| Atomized | Representative | 1 | 5 | 15 | 25 | 14 | 20 | 20 |
| Iron powder | Value | | | | | | | |
| A-N, | Representative | 1 | 5 | 15 | 25 | 14 | 20 | 20 |
| AA-AT | Value | | | | | | | |
| O, P | Representative | 2 | 6 | 24 | 21 | 13 | 16 | 18 |
| | Value | | | | | | | |
| Q-Z | Representative | 1 | 4 | 16 | 26 | 14 | 19 | 20 |
| | Value | | | | | | | |
| AU | Representative | 3 | 8 | 32 | 18 | 12 | 14 | 13 |
| | Value | | | | | | | |

*Minus Mesh/Plus Mesh: − means particles pass through a sieve having the nominal dimension (μm) and + means particles do not pass through a sieve having the nominal dimension (μm).

Regarding the obtained pure iron powder, the impurity content in the particles, the hardness, the number of crystal grains, the number of inclusions containing Si and having a size of 50 nm or more, the number of inclusions containing Si and having a size of 100 nm or more, and the circularity of the particles were measured.

In the iron powder particles, the impurity content of C, O, S, and N was measured by an infrared absorption method after combustion and the impurity content of Si, Mn, and P was measured by a high-frequency inductively coupled plasma (ICP) emission spectrometry. The hardness of the iron powder particles, the number of inclusions containing Si, and the circularity of the iron powder particles were measured by the same methods as described above. The results are shown in Tables 2 and 3.

TABLE 2

| Iron | | | | | | | |
|---|---|---|---|---|---|---|---|
| Powder | Chemical Components (mass %)* | | | | | | |
| No. | C | Si | Mn | P | S | O | N |
| A | 0.001 | 0.012 | 0.04 | 0.008 | 0.002 | 0.05 | 0.0009 |
| B | 0.001 | 0.012 | 0.05 | 0.006 | 0.003 | 0.07 | 0.0008 |
| C | 0.003 | 0.014 | 0.04 | 0.005 | 0.002 | 0.06 | 0.0006 |
| D | 0.001 | 0.015 | 0.03 | 0.007 | 0.002 | 0.05 | 0.0004 |
| E | 0.002 | 0.012 | 0.04 | 0.006 | 0.002 | 0.06 | 0.0006 |
| F | 0.003 | 0.012 | 0.04 | 0.005 | 0.001 | 0.09 | 0.0005 |
| G | 0.001 | 0.012 | 0.03 | 0.008 | 0.002 | 0.08 | 0.0004 |
| H | 0.002 | 0.014 | 0.04 | 0.006 | 0.002 | 0.06 | 0.0007 |
| I | 0.003 | 0.015 | 0.03 | 0.005 | 0.008 | 0.05 | 0.0008 |
| J | 0.001 | 0.012 | 0.04 | 0.007 | 0.002 | 0.07 | 0.0006 |
| K | 0.002 | 0.013 | 0.04 | 0.005 | 0.002 | 0.06 | 0.0007 |
| L | 0.003 | 0.011 | 0.07 | 0.005 | 0.001 | 0.04 | 0.0005 |
| M | 0.001 | 0.025 | 0.03 | 0.005 | 0.001 | 0,05 | 0.0004 |
| N | 0.002 | 0.013 | 0.04 | 0.005 | 0.002 | 0.06 | 0.0007 |
| O | 0,001 | 0.015 | 0.04 | 0.005 | 0.001 | 0.05 | 0.0004 |
| P | 0.002 | 0.014 | 0.04 | 0.006 | 0.002 | 0.05 | 0.0006 |
| AA | 0.001 | 0.014 | 0.03 | 0.007 | 0.002 | 0.05 | 0.0006 |
| AB | 0.002 | 0.012 | 0.04 | 0.007 | 0.002 | 0.06 | 0.0006 |
| AC | 0.001 | 0.012 | 0.04 | 0.005 | 0.002 | 0.05 | 0.0005 |
| Q | 0.007 | 0.014 | 0.04 | 0.005 | 0.002 | 0.06 | 0.0009 |
| R | 0.001 | 0.050 | 0.04 | 0.006 | 0.002 | 0.06 | 0.0007 |
| S | 0.003 | 0.015 | 0.25 | 0.008 | 0.002 | 0.08 | 0.0004 |
| T | 0.001 | 0.012 | 0.04 | 0.015 | 0.002 | 0.07 | 0.0006 |
| U | 0.001 | 0.012 | 0.04 | 0.007 | 0.021 | 0.06 | 0.0007 |
| V | 0.002 | 0.014 | 0.04 | 0.006 | 0.002 | 0.22 | 0.0007 |
| W | 0.003 | 0.012 | 0.04 | 0.005 | 0.001 | 0.09 | 0.0018 |
| X | 0.003 | 0.014 | 0.04 | 0.005 | 0.002 | 0.06 | 0.0006 |
| Y | 0.003 | 0.015 | 0.20 | 0.005 | 0.002 | 0.07 | 0.0006 |
| Z | 0.003 | 0.040 | 0.04 | 0.005 | 0.002 | 0.07 | 0.0006 |

*Balance: Fe

TABLE 3

| | | | Number of Inclusions | | | | |
|---|---|---|---|---|---|---|---|
| | | Number of | Containing Si (%)* | | | | |
| Iron | Hardness of | Crystal | Size | | | Green | |
| Powder | Particles | Grains in a | 50 nm | 100 nm | | Density | |
| No. | (Hv) | Particle | or more | or more | Circularity | (Mg/m³) | Remarks |
| A | 78 | 1.5 | 95 | 90 | 0.75 | 7.24 | Invention Example |
| B | 72 | 1.1 | 100 | 100 | 0.74 | 7.27 | Invention Example |
| C | 75 | 3.5 | 75 | 70 | 0.75 | 7.25 | Invention Example |
| D | 74 | 3.0 | 80 | 75 | 0.76 | 7.25 | Invention Example |
| E | 72 | 1.6 | 95 | 95 | 0.74 | 7.26 | Invention Example |
| F | 79 | 2.5 | 85 | 80 | 0.73 | 7.24 | Invention Example |
| G | 78 | 2.2 | 80 | 80 | 0.77 | 7.24 | Invention Example |
| H | 74 | 1.9 | 85 | 85 | 0.77 | 7.26 | Invention Example |
| I | 79 | 1.2 | 95 | 85 | 0.74 | 7.24 | Invention Example |
| J | 74 | 1.5 | 85 | 80 | 0.75 | 7.26 | Invention Example |
| K | 72 | 1.3 | 90 | 80 | 0.76 | 7.27 | Invention Example |
| L | 78 | 1.5 | 85 | 85 | 0.74 | 7.24 | Invention Example |
| M | 78 | 1.2 | 95 | 90 | 0.77 | 7.24 | Invention Example |
| N | 74 | 3.8 | 65 | 60 | 0.71 | 7.24 | Invention Example |
| O | 77 | 1.6 | 90 | 90 | 0.85 | 7.25 | Invention Example |
| P | 75 | 3.6 | 70 | 60 | 0.9 | 7.26 | Invention Example |
| AA | 75 | 2.1 | 80 | 75 | 0.68 | 7.25 | Invention Example |
| AB | 76 | 1.8 | 85 | 85 | 0.67 | 7.24 | Invention Example |
| AC | 73 | 1.7 | 95 | 90 | 0.64 | 7.24 | Invention Example |
| Q | 85 | 5.0 | 80 | 65 | 0.75 | 7.18 | Comparative Example |
| R | 90 | 6.5 | 75 | 70 | 0.76 | 7.19 | Comparative Example |
| S | 94 | 4.0 | 80 | 75 | 0.74 | 7.16 | Comparative Example |
| T | 93 | 3.0 | 80 | 70 | 0.74 | 7.17 | Comparative Example |
| U | 87 | 2.5 | 85 | 80 | 0.73 | 7.14 | Comparative Example |
| V | 92 | 3.5 | 80 | 70 | 0.76 | 7.18 | Comparative Example |
| W | 86 | 5.3 | 75 | 75 | 0.75 | 7.19 | Comparative Example |
| X | 84 | 7.5 | 70 | 70 | 0.76 | 7.21 | Comparative Example |
| Y | 96 | 4.5 | 60 | 55 | 0.74 | 7.13 | Comparative Example |
| Z | 82 | 4.0 | 70 | 60 | 0.68 | 7.17 | Comparative Example |

*The ratio (%) to the total number of inclusions containing Si

After 0.75% by mass of zinc stearate powder was blended into the obtained pure iron powder (1000 g), the mixture was mixed using a V type mixer for 15 minutes to obtain mixed powder. The mixed powder was placed in a die and formed into a cylindrical green compact (11 mmφ×10 mm) at room temperature (about 25° C.) at a compacting pressure of 686 MPa. The density (green density) of the obtained green compact was measured by an Archimedes method to evaluate the compressibility of the iron powder.

The green density of the green compact is also shown in Table 3.

In our examples, all of the green compacts have a high green density of 7.24 Mg/m³ or more, which means they are the iron powder with high compressibility. In comparative examples that depart from our, range, green compacts have a green density of less than 7.24 Mg/m³, which means their compressibility is lower.

### Example 2

Regarding the iron powder shown in Tables 2 and 3, insulating layers made of aluminum phosphate were formed on the surfaces of the iron powder particles through an insulation coating process using a spraying method. The insulation coating process was conducted as follows. Orthophosphoric acid and aluminum chloride were blended in a ratio of 2 to 1 of P and Al on a molar basis to obtain an aqueous solution whose total solid content was 5% by mass (solution for an insulation coating process). To form the insulating layers, the solution for an insulation coating process was sprayed and dried in such a manner that the solid content was 0.25% by mass relative to the total amount of the iron powder and the solid content of the solution.

After 5% by mass of an alcohol suspension of zinc stearate was applied in a die to conduct die lubrication, the obtained insulating-layer-coated iron powder was placed in the die and compacted into a ring-shaped green compact (outside diameter of 38 mmφ×inside diameter of 20 mmφ×height of 6 mm) at room temperature (about 25° C.) at a compacting pressure of 980 MPa. The resulting green compact was annealed at 200° C. in air for 1 h to obtain a dust core.

Next, the density and magnetic characteristics of the resulting dust core were measured.

The density was determined by measuring the mass and the dimensions (outside diameter, inside diameter, and height) of the dust core. The magnetic characteristics to be measured were magnetic flux density and maximum permeability (a maximum value among values (permeability) represented by a ratio of the measured permeability to permeability in a vacuum). After coil wire was wound with 100 turns on the dust core to obtain a primary coil and another coil wire was wound with 20 turns on the same dust core to obtain a secondary coil, the magnetic characteristics were measured with a maximum applied magnetic field of 10 kA/m using a direct current magnetization measurement device.

The results are shown in Table 4.

TABLE 4

| | | | Magnetic Characteristics | | |
|---|---|---|---|---|---|
| | Iron | Green | Magnetic | | |
| Core | Powder | Density | Flux | Maximum | |
| No. | No. | (Mg/m³) | Density (T) | Permeability | Remarks |
| 1 | A | 7.60 | 1.60 | 401 | Invention |
| | | | | | Example |
| 2 | B | 7.64 | 1.63 | 445 | Invention |
| | | | | | Example |
| 3 | C | 7.61 | 1.61 | 405 | Invention |
| | | | | | Example |
| 4 | D | 7.62 | 1.61 | 418 | Invention |
| | | | | | Example |
| 5 | E | 7.63 | 1.62 | 434 | Invention |
| | | | | | Example |
| 6 | F | 7.61 | 1.61 | 408 | Invention |
| | | | | | Example |
| 7 | G | 7.60 | 1.60 | 398 | Invention |
| | | | | | Example |
| 8 | H | 7.62 | 1.61 | 419 | Invention |
| | | | | | Example |
| 9 | I | 7.61 | 1.61 | 411 | Invention |
| | | | | | Example |
| 10 | J | 7.62 | 1.61 | 422 | Invention |
| | | | | | Example |
| 11 | K | 7.63 | 1.62 | 432 | Invention |
| | | | | | Example |
| 12 | L | 7.61 | 1.61 | 404 | Invention |
| | | | | | Example |
| 13 | M | 7.60 | 1.60 | 400 | Invention |
| | | | | | Example |
| 27 | AA | 7.60 | 1.60 | 405 | Invention |
| | | | | | Example |
| 28 | AB | 7.60 | 1.60 | 408 | Invention |
| | | | | | Example |
| 29 | AC | 7.61 | 1.61 | 416 | Invention |
| | | | | | Example |
| 14 | N | 7.58 | 1.58 | 370 | Invention |
| | | | | | Example |
| 15 | O | 7.61 | 1.61 | 420 | Invention |
| | | | | | Example |
| 16 | P | 7.63 | 1.62 | 442 | Invention |
| | | | | | Example |
| 17 | Q | 7.55 | 1.56 | 365 | Comparative |
| | | | | | Example |
| 18 | R | 7.55 | 1.55 | 360 | Comparative |
| | | | | | Example |
| 19 | S | 7.53 | 1.54 | 344 | Comparative |
| | | | | | Example |
| 20 | T | 7.54 | 1.54 | 340 | Comparative |
| | | | | | Example |
| 21 | U | 7.52 | 1.53 | 330 | Comparative |
| | | | | | Example |
| 22 | V | 7.55 | 1.55 | 349 | Comparative |
| | | | | | Example |
| 23 | W | 7.56 | 1.55 | 356 | Comparative |
| | | | | | Example |
| 24 | X | 7.57 | 1.56 | 362 | Comparative |
| | | | | | Example |
| 25 | Y | 7.51 | 1.51 | 313 | Comparative |
| | | | | | Example |
| 26 | Z | 7.58 | 1.57 | 375 | Comparative |
| | | | | | Example |

In our examples, all of the dust cores have high green density, high magnetic flux density, and high maximum permeability, which means a dust core having excellent magnetic characteristics can be manufactured from the iron powder. In comparative examples that depart from our range, green density is lower and magnetic flux density and/or maximum permeability are lower.

### Example 3

After the pure iron powder AD to AU whose particle size distributions are shown in Table 1 were manufactured by an atomizing method, the characteristics of the iron powder and the dust core were examined in a way similar to EXAMPLEs 1 and 2. The composition and reduction temperature of the iron powder are shown in Table 5, and the various characteristics of the obtained iron powder are shown in Table 6. The characteristics of the dust core are shown in Table 7. The holding time in the reduction process was 3.5 to 5 h.

The points different from EXAMPLEs 1 and 2 are listed below.
Iron powders AD to AG and AS: the stress relief annealing temperature was 800° C. and the processing time was varied in a range of 1 to 3 h. Other manufacturing conditions were the same among these iron powders.
Iron powders AH to AR: the reduction temperature was varied for AH to AN, and the atomizing water pressure was varied for AO to AQ. Other conditions were the same among these iron powders. The water pressures of the iron powders were decreased in the order of AO, AP, and AQ (i.e. AO>AP>AQ). Regarding AR, the particles were made by a gas atomizing method, and the following processing conditions were the same as those for AO or the like.
Iron powder AT: in the reannealing after the reduction process, Ni powder having an average particle size of 8 μm and molybdenum oxide powder having an average particle size of 3 μm were mixed, and the Ni powder and the Mo powder diffused and adhered to the surfaces of the iron powder. The amounts of Ni and Mo were 2% and 1% by mass, respectively, relative to the total amount of Ni, Mo, and the iron powder. In a compression test, graphite powder (average particle size 3 μm) and zinc stearate powder (average particle size 12 μm) were added. However, the result of the compaction without adding graphite was also shown for the purpose of evaluation without the influence of graphite on green density. The amounts of Ni, Mo, and graphite were 2.0%, 1.0%, and 0.6% by mass, respectively, relative to the total amount of Ni, Mo, graphite, and iron powder. The amount of zinc stearate powder was 0.75% by mass relative to the amount of the above-mentioned mixed powder. Since iron powder AT was mainly for machine parts, the dust core was not made and the characteristics of the dust core were not examined.
AU: the manufacturing conditions were the same as AD or the like except that the particle size distribution shown in Table 1 was obtained by adjusting the mixing ratio in a sieve classification process.
Cores 31 to 47: the insulation coating process was conducted using an iron phosphate coating such that the resulting film had an average thickness of 80 nm. In the insulation coating process, heat treatment was carried out at 400° C. for 60 minutes (insulation coating A).

Core 48: the insulation coating process was conducted using an epoxy resin such that the resulting film had an average thickness of 90 nm. In the insulation coating process, baking treatment was carried out at 200° C. for 60 minutes (insulation coating B).

Core 49: the insulation coating process was conducted using a silicone resin such that the resulting film had an average thickness of 70 nm. In the insulation coating process, baking treatment was carried out at 500° C. for 60 minutes (insulation coating C).

Core 50: the insulation coating process was conducted using a polyimide resin such that the resulting film had an average thickness of 80 nm. In the insulation coating process, baking treatment was carried out at 400° C. for 60 minutes (insulation coating D).

TABLE 5

| | | | | | | | | Reduction |
|---|---|---|---|---|---|---|---|---|
| Iron | | | | | | | | Temper- |
| Powder | Chemical Components (mass %)* | | | | | | | ature |
| No. | C | Si | Mn | P | S | O | N | (° C.) |
| AD | 0.003 | 0.018 | 0.05 | 0.007 | 0.002 | 0.10 | 0.0004 | 900 |
| AE | 0.003 | 0.017 | 0.05 | 0.007 | 0.002 | 0.10 | 0.0008 | 900 |
| AF | 0.003 | 0.018 | 0.05 | 0.006 | 0.002 | 0.10 | 0.0012 | 900 |
| AG | 0.003 | 0.018 | 0.05 | 0.007 | 0.002 | 0.10 | 0.0017 | 900 |
| AH | 0.006 | 0.017 | 0.05 | 0.007 | 0.002 | 0.13 | 0.0008 | 680 |
| AI | 0.003 | 0.017 | 0.05 | 0.007 | 0.002 | 0.12 | 0.0008 | 800 |
| AJ | 0.003 | 0.017 | 0.05 | 0.007 | 0.002 | 0.11 | 0.0008 | 850 |
| AK | 0.003 | 0.017 | 0.05 | 0.007 | 0.002 | 0.10 | 0.0008 | 900 |
| AL | 0.003 | 0.017 | 0.05 | 0.007 | 0.002 | 0.10 | 0.0008 | 930 |
| AM | 0.003 | 0.017 | 0.05 | 0.007 | 0.002 | 0.09 | 0.0008 | 960 |
| AN | 0.003 | 0.017 | 0.05 | 0.007 | 0.002 | 0.08 | 0.0008 | 1000 |
| AO | 0.003 | 0.017 | 0.05 | 0.007 | 0.002 | 0.10 | 0.0008 | 900 |
| AP | 0.003 | 0.017 | 0.05 | 0.007 | 0.002 | 0.10 | 0.0008 | 900 |
| AQ | 0.003 | 0.017 | 0.05 | 0.007 | 0.002 | 0.10 | 0.0008 | 900 |
| AR | 0.003 | 0.017 | 0.05 | 0.007 | 0.002 | 0.10 | 0.0008 | 900 |
| AS | 0.003 | 0.005 | 0.05 | 0.007 | 0.002 | 0.11 | 0.0017 | 900 |
| AT | 0.003 | 0.017 | 0.05 | 0.007 | 0.002 | 0.12 | 0.0008 | 900 |
| AU | 0.003 | 0.017 | 0.05 | 0.007 | 0.002 | 0.12 | 0.0008 | 900 |

*Balance: Fe

TABLE 6

| | | | Number of Inclusions | | | | | |
|---|---|---|---|---|---|---|---|---|
| | | Number of | Containing Si (%)*¹ | | | | | |
| Iron | Hardness of | Crystal | Size | | | Green | | |
| Powder | Particles | Grains in a | 50 nm | 100 nm | | Density | | |
| No. | (Hv) | Particle | or more | or more | Circularity | (Mg/m³) | Others | Remarks |
| AD | 70 | 2.1 | 85 | 95 | 0.73 | 7.26 | | Invention |
| | | | | | | | | Example |
| AE | 75 | 2.6 | 80 | 90 | 0.75 | 7.25 | | Invention |
| | | | | | | | | Example |
| AF | 79 | 3.4 | 75 | 80 | 0.72 | 7.24 | | Invention |
| | | | | | | | | Example |
| AG | 87 | 3.9 | 65 | 75 | 0.75 | 7.22 | | Comparative |
| | | | | | | | | Example |
| AH | 95 | 4.6 | 60 | 70 | 0.76 | 7.20 | | Comparative |
| | | | | | | | | Example |
| AI | 75 | 3.0 | 80 | 90 | 0.77 | 7.25 | | Invention |
| | | | | | | | | Example |
| AJ | 74 | 2.8 | 80 | 90 | 0.75 | 7.25 | | Invention |
| | | | | | | | | Example |
| AK | 72 | 2.3 | 80 | 90 | 0.76 | 7.25 | | Invention |
| | | | | | | | | Example |
| AL | 73 | 3.2 | 85 | 90 | 0.75 | 7.25 | | Invention |
| | | | | | | | | Example |
| AM | 77 | 2.6 | 85 | 95 | 0.77 | 7.24 | | Invention |
| | | | | | | | | Example |
| AN | 82 | 2.3 | 90 | 100 | 0.76 | 7.22 | | Comparative |
| | | | | | | | | Example |
| AO | 78 | 3.7 | 80 | 90 | 0.64 | 7.24 | | Invention |
| | | | | | | | | Example |
| AP | 78 | 3.4 | 80 | 90 | 0.70 | 7.25 | | Invention |
| | | | | | | | | Example |
| AQ | 77 | 3.1 | 80 | 90 | 0.78 | 7.25 | | Invention |
| | | | | | | | | Example |
| AR | 76 | 2.6 | 85 | 90 | 0.92 | 7.26 | | Invention |
| | | | | | | | | Example |
| AS | 78 | 2.5 | 85 | 95 | 0.74 | 7.25 | Atomizing Nozzle | Comparative |
| | | | | | | | Clogging Incidence | Example |
| | | | | | | | Rate: Twice | |
| AT | 80 | 3.9 | 80 | 90 | 0.72 | 7.20, | Ni: 2.0%, Mo: 1.0% | Invention |
| | | | | | | 7.24*³ | Diffused and Adhered, | Example |
| | | | | | | | Graphite: 0.6% Added*² | |
| AU | 75 | 2.9 | 80 | 90 | 0.73 | 7.24 | Cost Increase due to | Invention |
| | | | | | | | Particle Size | Example |
| | | | | | | | Distribution | |

*¹% relative to the total number of inclusions containing Si
*²The value relative to the total amount of iron powder + Ni powder + Mo powder
*³Bottom: green density in a case of the compaction without adding graphite

TABLE 7

| | Iron | | Green | Magnetic Characteristics | | |
|---|---|---|---|---|---|---|
| Core | Powder | Insulation | Density | Magnetic Flux | Maximum | |
| No. | No. | Coating* | (Mg/m³) | Density (T) | Permeability | Remarks |
| 31 | AD | A | 7.62 | 1.62 | 426 | Invention Example |
| 32 | AE | A | 7.61 | 1.61 | 412 | Invention Example |
| 33 | AF | A | 7.60 | 1.60 | 406 | Invention Example |
| 34 | AG | A | 7.57 | 1.58 | 380 | Comparative Example |
| 35 | AH | A | 7.60 | 1.60 | 400 | Comparative Example |
| 36 | AI | A | 7.60 | 1.60 | 405 | Invention Example |
| 37 | AJ | A | 7.60 | 1.60 | 406 | Invention Example |
| 38 | AK | A | 7.60 | 1.60 | 402 | Invention Example |
| 39 | AL | A | 7.61 | 1.61 | 411 | Invention Example |
| 40 | AM | A | 7.60 | 1.60 | 403 | Invention Example |
| 41 | AN | A | 7.57 | 1.58 | 378 | Comparative Example |
| 42 | AO | A | 7.60 | 1.60 | 410 | Invention Example |
| 43 | AP | A | 7.60 | 1.60 | 405 | Invention Example |
| 44 | AQ | A | 7.60 | 1.60 | 403 | Invention Example |
| 45 | AR | A | 7.63 | 1.64 | 433 | Invention Example |
| 46 | AS | A | 7.60 | 1.61 | 417 | Comparative Example |
| 47 | AU | A | 7.60 | 1.60 | 406 | Invention Example |
| 48 | AE | B | 7.59 | 1.59 | 408 | Invention Example |
| 49 | AE | C | 7.61 | 1.61 | 414 | Invention Example |
| 50 | AE | D | 7.60 | 1.60 | 408 | Invention Example |

*A: iron phosphate (average film thickness 80 nm)
B: epoxy resin (average film thickness 90 nm)
C: silicone resin (average film thickness 70 nm)
D: polyimide resin (average film thickness 80 nm)
Note:
iron powder AT was not examined because it was not supposed to be used as a material for a dust core.

As is evident from the results of AD to AN, the micro Vickers hardness of the iron powder particles can be reduced to 80 or less by decreasing the content of N or conducting a reduction process under high heat load, which provides good compressibility. Furthermore, the micro Vickers hardness of the iron powder particles can be reduced to 75 or less by optimizing the reduction process, which provides better compressibility.

From the results of AO to AR, compressibility can be further improved by optimizing the circularity. The compressibility is excellent in the case of a circularity of 0.9 or more, whereas sufficiently high compressibility can be obtained even if the circularity is about 0.7 to 0.8 that is achievable by a water atomizing method.

From the result of AS, when the content of Si is reduced to 0.010% or less, it is advantageous to decrease the hardness of the particles; however, the productivity significantly declines.

From the result of AT, compressibility can be ensured even if an alloying powder is suitably added.

From the result of AU, good compressibility can be obtained regardless of the particle size distribution as long as production cost is not considered.

### INDUSTRIAL APPLICABILITY

We provide industrially significant advantages because a green compact with high density can be manufactured less expensively and steadily, that is, sintered parts with high strength or parts such as dust cores having excellent magnetic characteristics can be manufactured at low cost.

Moreover, since the high compressibility iron powder is obtained from a melt having the same impurity content as that of common iron powder for powder metallurgy, special refining to achieve high purity is not required and there is substantially no concern about a significant increase in manufacturing cost.

1-6. (canceled)

7. High compressibility iron powder comprising:
iron powder that includes, in percent by mass, C: 0.005% or less, Si: more than 0.01% and 0.03% or less, Mn: 0.03% or more and 0.07% or less, P: 0.01% or less, S: 0.01% or less, O: 0.10% or less, and N: 0.001% or less;
wherein a number of crystal grains included in a particle of the iron powder is four or less on average in a cross-section of the particle and the particle has a micro Vickers hardness (Hv) of 80 or less on average.

8. The high compressibility iron powder according to claim 7, wherein circularity of the particle is 0.7 or more on average.

9. The high compressibility iron powder according to claim 7, wherein the particle includes inclusions such that a ratio of a number of the inclusions containing Si and having a size of 50 nm or more to a total number of the inclusions containing Si is 70% or more.

10. The high compressibility iron powder according to claim 8, wherein the particle includes inclusions such that a ratio of a number of the inclusions containing Si and having a size of 50 nm or more to a total number of the inclusions containing Si is 70% or more.

11. The high compressibility iron powder according to claim 7, wherein the iron powder is atomized iron powder manufactured by a water atomizing method.

12. The high compressibility iron powder according to claim 8, wherein the iron powder is atomized iron powder manufactured by a water atomizing method.

13. Iron powder for a dust core obtained by conducting an insulation coating process on the high compressibility iron powder according to claim 7.

14. Iron powder for a dust core obtained by conducting an insulation coating process on the high compressibility iron powder according to claim 8.

15. Iron powder for a dust core obtained by conducting an insulation coating process on the high compressibility iron powder according to claim 9.

16. Iron powder for a dust core obtained by conducting an insulation coating process on the high compressibility iron powder according to claim 10.

17. Iron powder for a dust core obtained by conducting an insulation coating process on the high compressibility iron powder according to claim 11.

18. Iron powder for a dust core obtained by conducting an insulation coating process on the high compressibility iron powder according to claim 12.

19. A dust core obtained by compacting the iron powder for a dust core according to claim 13.

20. A dust core obtained by compacting the iron powder for a dust core according to claim 14.

21. A dust core obtained by compacting the iron powder for a dust core according to claim 15.

22. A dust core obtained by compacting the iron powder for a dust core according to claim 16.

23. A dust core obtained by compacting the iron powder for a dust core according to claim 17.

24. A dust core obtained by compacting the iron powder for a dust core according to claim 18.
